(19) United States
(12) Patent Application Publication
(10) Pub. No.: US 2014/0147410 A1
(43) Pub. Date: May 29, 2014

(54) MICROBICIDE COMBINATIONS CONTAINING SILVER

(71) Applicant: Rohm and Haas Company, (US)

(72) Inventors: Tirthankar Ghosh, Oreland, PA (US); Kiran Pareek, Bensalem, PA (US)

(21) Appl. No.: 14/129,589

(22) PCT Filed: Jun. 29, 2012
(86) PCT No.: PCT/US12/44785

§ 371 Date: Dec. 27, 2013

Related U.S. Application Data
(60) Provisional application No. 61/503,637, filed on Jul. 1, 2011.

(51) Int. Cl. A01N 55/02; A01N 41/10

(52) U.S. Cl. CPC A01N 55/02; A01N 41/10
USPC 424/78.32

(57) ABSTRACT

A synergistic microbicidal composition. The composition comprises: (a) silver ion; and (b) diiodomethyl-p-tolylsulfone; wherein a weight ratio of silver to diiodomethyl-p-tolylsulfone is from 1: 1/0.008 to 1/0.1, 1/0.13 to 1/8 or 1/120 to 1/280.

The present invention relates to microbicide combinations containing silver and diiodomethyl-p-tolylsulfone (DIMTS).

A combination of DIMTS with zinc is disclosed in U.S. App. No. 2006/0171911. However, this reference does not teach the combination claimed in the present application.

Use of combinations of at least two antimicrobial compounds can broaden potential markets, reduce use concentrations and costs, and reduce waste. In some cases, commercial antimicrobial compounds cannot provide effective control of microorganisms, even at high use concentrations, due to weak activity against certain types of microorganisms, e.g., those resistant to some antimicrobial compounds. Combinations of different antimicrobial compounds are sometimes used to provide overall control of microorganisms in a particular end use environment. The problem addressed by this invention is to provide additional synergistic combinations of antimicrobial compounds.

### STATEMENT OF THE INVENTION

The present invention is directed to a synergistic microbicidal composition. The composition comprises: (a) silver ion; and (b) diiodomethyl-p-tolylsulfone; wherein a weight ratio of silver to diiodomethyl-p-tolylsulfone is from 1: 1/0.008 to 1/0.1, 1/0.13 to 1/8 or 1/120 to 1/280.

### DETAILED DESCRIPTION OF THE INVENTION

Preferably, the silver ion (Ag(I)) is present in the composition as a complex with a polymeric delivery system, preferably a copolymer comprising polymerized units of a monomer X and a monomer Y; wherein monomer X is an ethylenically unsaturated compound having a substituent group selected from an unsaturated or aromatic heterocyclic group having at least one hetero atom selected from N, O and S; preferably the substituent group is selected from an unsaturated or aromatic heterocyclic group having at least one hetero N atom; and wherein monomer Y is an ethylenically unsaturated compound selected from carboxylic acids, carboxylic acid salts, carboxylic acid esters (preferably alkyl esters, hydroxyalkyl esters, polyethylene glycol esters, etc.), organosulfuric acids, organosulfuric acid salts, sulfonic acids, sulfonic acid salts, phosphonic acids, phosphonic acid salts, vinyl esters (e.g., vinyl C₁-C₈ alkanoates), (meth)acrylamides, C₈-C₂₀ aromatic monomers containing at least one exocyclic ethylenic unsaturation and combinations thereof.

The term “copolymer” as used herein refers to polymers polymerized from at least two different monomers. Percentages herein are by weight, unless specified otherwise. Monomer unit percentages are based on total copolymer weight.

The term “aqueous” as used herein means water and mixtures composed substantially of water and water miscible solvents.

The use of the term “(meth)” followed by another term such as acrylic, acrylate, acrylamide, etc., as used herein and in the appended claims, refers to, for example, both acrylic and methacrylic; acrylate and methacrylate; acrylamide and methacrylamide; etc.

The glass transition temperature (“Tg”) for the copolymers and pressure sensitive adhesive formulations of the present invention may be measured by differential scanning calorimetry (DSC) taking the mid-point in the heat flow versus temperature transition as the Tg value. Preferably, the copolymer comprises at least 15 wt % of monomer X derived units. Preferably, the copolymer comprises at least 20 wt % of monomer X derived units, preferably at least 25 wt %, preferably at least 30 wt %, preferably at least 35 wt %, preferably at least 40 wt %. Preferably, the copolymer comprises no more than 60 wt % of monomer X derived units, preferably no more than 55 wt %, preferably no more than 50 wt %.

Preferably, monomer X is selected from vinylimidazoles, vinylimidazolines, vinylpyridines, vinylpyrroles, derivatives thereof and combinations thereof. Preferably, monomer X is selected from vinylimidazoles, vinylpyridines, derivatives thereof and combinations thereof. Preferably, monomer X is selected from N-vinylimidazole, 2-vinylpyridine, 4-vinylpyridine and combinations thereof. Preferably, monomer X is N-vinylimidazole (VI).

Preferably, monomer Y is selected from carboxylic acids, carboxylic acid salts, carboxylic acid esters, organosulfuric acids, organosulfuric acid salts, sulfonic acids, sulfonic acid salts, phosphonic acids, phosphonic acid salts, vinyl esters, (meth)acrylamides, C₈-C₂₀ aromatic monomers containing at least one exocyclic ethylenic unsaturation and combinations thereof. Preferably, monomer Y is selected from carboxylic acids, carboxylic acid esters (e.g., alkyl (meth)acrylates), (meth)acrylamides, C₈-C₂₀ aromatic monomers containing at least one exocyclic ethylenic unsaturation and combinations thereof. Preferably, monomer Y is selected from acrylic acid (AA), methacrylic acid, itaconic acid, maleic acid, fumaric acid, methyl (meth)acrylate, ethyl (meth)acrylate, propyl (meth)acrylate, isopropyl acrylate, n-butyl (meth)acrylate, isobutyl (meth)acrylate, 2-ethylhexyl (meth)acrylate, decyl (meth)acrylate, lauryl (meth)acrylate, stearyl (meth)acrylate, styrene, vinyltoluene, α-methylstyrene and combinations thereof. Preferably, monomer Y comprises at least one C₂-C₈ alkyl (meth)acrylate, alternatively n-butyl (meth)acrylate, alternatively monomer Y comprises n-butyl acrylate (BA) and acrylic acid.

Preferably, the copolymer comprises no more than 5 wt % of units derived from ethylenically unsaturated monomer containing an epoxide function, preferably no more than 1 wt %, preferably no more than 0.5 wt %, preferably no more than 0.1 wt %, preferably no more than 0.05 wt %.

Preferably, the composition comprising a copolymer has a pH from 3.5 to 10, preferably from 4 to 10, preferably from 4 to 10, preferably from 4.5 to 10, preferably from 4 to 9, preferably from 4 to 8, preferably from 4.5 to 7.5, preferably from 5 to 10, preferably from 6 to 10, preferably from 7 to 10, preferably from 8 to 10.

Preferably, the composition comprising a copolymer comprises at least 20 wt % solids. Preferably, the composition comprises at least 25 wt % solids. Preferably, the composition comprises at least 30 wt % solids.

If the copolymer comprises polymerized units derived from a crosslinker, preferably the crosslinkers are multi-ethylenically unsaturated monomers, preferably, selected from 1,4-butanediol diacrylate; 1,4-butanediol dimethacrylate; 1,6-hexanediol diacrylate; 1,1,1-trimethylol propane triacrylate; 1,1,1-trimethylol propane trimethacrylate; allyl methacrylate; divinylbenzene; and N-allyl acrylamide. Preferably, the crosslinker derived units are derived from crosslinker selected from 1,1,1-trimethylol propane trimethacrylate. If crosslinkers are present, preferably the copolymer comprises 0.01 to 10 wt % (based on solids) crosslinker, preferably 0.01 to 5 wt %, preferably 0.01 to 1 wt %.

Preferably, the copolymer comprises from 1.5 wt % to 20 wt % silver based on total weight of copolymer and silver, alternatively from 2.5 wt % to 15 wt %, alternatively from 5 wt % to 11.5 wt %, alternatively from 6.5 wt % to 8.5 wt %. Silver is in the form of Ag(I) ion, which typically is introduced in the form of silver nitrate. Methods for preparation of the copolymer have been disclosed previously, e.g., in U.S. Pat. No. 7,335,613.

The specific amount of the composition of this invention necessary to inhibit or control the growth of microorganisms in an application will vary. Typically, the amount of the composition of the present invention is sufficient to control the growth of microorganisms if it provides from 0.1 to 25,000 ppm (parts per million) active ingredient of the composition (as silver plus co-biocide combined). It is preferred that the active ingredients of the composition be present in the locus in an amount of at least 0.1 ppm, more preferably at least 5 ppm, more preferably at least 50 ppm and most preferably at least 500 ppm. In one embodiment of the invention, the active ingredients are present in an amount of at least 2,000 ppm. It is preferred that the active ingredients of the composition be present in the locus in an amount of no more than 20,000 ppm, more preferably no more than 15,000 ppm, more preferably no more than 5,000 ppm. Preferably, the active ingredients are present in an amount of no more than 15,000 ppm, more preferably no more than 8,000 ppm, and most preferably no more than 3,000 ppm.

### EXAMPLES

The silver-containing copolymer tested in these Examples comprises a polymer having 45% BA monomer units, 45% VI monomer units and 10% AA monomer units, based on polymer weight, and containing 7.8% silver ion, based on total weight of polymer and silver. The silver-containing polymer was formulated in water at 39% solids and pH 11.

The combinations were evaluated for synergy by determining the synergy index (S.I.) of the combination. The Synergy index calculated is based on minimum inhibitory concentrations (MIC) of two biocides (A and B) alone and in combinations. The lower the S.I. value, the better the synergy.

High Resolution Minimum Inhibitory Concentration (HRMIC) method was performed to determine the potential for synergy of the combinations. The tests organisms were gram negative bacteria (Pseudomonas aeruginosa), Gram positive bacteria (Staphylococcus aureus), yeast (Candida albicans) and mold (Aspergillus niger). Contact time for the bacteria was 24 and 48 hours, yeast was 48 and 72 hrs, 3 and 7 days for mold. The test was carried out in 96well microtiter plates.

The test results for demonstration of synergy of the MIC combinations are shown below in Tables 1 through 4. Each table shows the combinations of two components results against the microorganisms tested with incubation times; the end-point activity in ppm measured by the MIC for compound A alone (CA), for component B alone (CB), and the mixture (Ca) and (Cb); the calculated SI value; and the range of synergistic ratios for each combination tested.

Ca/CA+Cb/CB=Synergy Index(“SI”)

### Wherein:

CA=concentration of compound A in ppm, acting alone, which produced an end point (MIC of Compound A).
Ca=concentration of compound A in ppm, in the mixture, which produced an end point.
CB=concentration of compound B in ppm, acting alone, which produced an end point (MIC of Compound B).
Cb=concentration of compound B in ppm, in the mixture, which produced an end point.

When the sum of Ca/CA and Cb/CB is greater than one, antagonism is indicated. When the sum is equal to one, additivity is indicated, and when less than one, synergism is demonstrated.

Preservatives Used

| Abbreviations | Active ingredient | Supplier | AI % | Solvent |
|---|---|---|---|---|
| silver-containing | Silver | The Dow | 3 | MQ H₂O |
| copolymer | | Chemical Co. | | |
| AMICAL ™ 48 | Diiodomethyl-p- | The Dow | 95 | Ethanol |
| biocide | tolysulfone (DIMTS) | Chemical Co. | | |

Inoculums Used
Inoculum Size of organisms ( CFU/ml )

| Staphylococcus. | Pseudomonas | Aspergillus | Candida |
|---|---|---|---|
| aureus | aeruginosa ATCC # | niger | albicans |
| ATCC# 6538 | 15442 | ATCC# 16404 | ATCC#10203 |
| 1.2 × 10⁷ | 1.2 × 10⁷ | 1.2 × 10⁵ | 5.3 × 10⁵ |

Media Used
Media Used for testing

| Staphylococcus | Pseudomonas | Aspergillus | Candida |
|---|---|---|---|
| aureus | aeruginosa ATCC # | niger | albicans |
| ATCC# 6538 | 15442 | ATCC# 16404 | ATCC#10203 |
| TSB | TSB | PDB | PDB |

TABLE 1

| Test | Contact | | | | |
|---|---|---|---|---|---|
| Organisms | Time | Ca | Cb | S.I. | Ca:Cb |
| A. niger | 3rd day | 5 | — | — | — |
| ATCC | | — | 0.3 | — | — |
| #16404 | | | | | |
| | | 2.5 | 0.02 | 0.57 | 1:0.0080 |
| | | 2.5 | 0.1 | 0.83 | 1:0.0400 |
| | | 2.5 | 0.2 | 1.17 | 1:0.0800 |
| | | 1.25 | 0.06 | 0.45 | 1:0.0480 |
| | | 1.25 | 0.1 | 0.58 | 1:0.0800 |
| | | 1.25 | 0.2 | 0.92 | 1:0.1600 |
| | | 0.65 | 0.3 | 1.13 | 1:0.4615 |
| | | 0.35 | 0.3 | 1.07 | 1:0.8571 |
| | | 0.17 | 0.3 | 1.03 | 1:1.7647 |
| | 7th day | 5 | — | — | — |
| | | — | 0.5 | — | — |
| | | 2.5 | 0.03 | 0.56 | 1:0.0120 |
| | | 2.5 | 0.2 | 0.9 | 1:0.0800 |
| | | 2.5 | 0.3 | 1.1 | 1:0.1200 |
| | | 1.25 | 0.4 | 1.05 | 1:0.3200 |
| | | 0.65 | 0.4 | 0.93 | 1:0.6154 |
| | | 0.65 | 0.5 | 1.13 | 1:0.7692 |
| | | 0.35 | 0.5 | 1.07 | 1:1.4286 |
| | | 0.17 | 0.5 | 1.03 | 1:2.9412 |

Ca: component in ppm AI (silver ion) of Silver-containing copolymer
Cb: component in ppm AI of DIMTS
Note:
MIC alone (CA and CB) is on the upper rows.

TABLE 2

| Test Organisms | Contact Time | Ca | Cb | S.I. | Ca:Cb |
|---|---|---|---|---|---|
| C. albicans | 48 hrs | 20 | — | — | — |
| ATCC #10203 | | — | 20 | — | — |
| | | 10 | 0.08 | 0.50 | 1:0.0080 |
| | | 10 | 0.8 | 0.54 | 1:0.0800 |
| | | 10 | 10 | 1.00 | 1:1.0000 |
| | | 5 | 0.5 | 0.28 | 1:0.1000 |
| | | 5 | 5 | 0.50 | 1:1.0000 |
| | | 5 | 10 | 0.75 | 1:2.0000 |
| | | 5 | 20 | 1.25 | 1:4.0000 |
| | | 2.5 | 20 | 1.13 | 1:8.0000 |
| | | 1.25 | 20 | 1.06 | 1:16.0000 |
| | | 0.65 | 20 | 1.03 | 1:30.7692 |
| | | 0.35 | 20 | 1.02 | 1:57.1429 |
| | | 0.17 | 20 | 1.01 | 1:117.6471 |
| | 72 hrs | 20 | — | — | — |
| | | — | 30 | — | — |
| | | 10 | 0.08 | 0.50 | 1:0.0080 |
| | | 10 | 8 | 0.77 | 1:0.8000 |
| | | 10 | 10 | 0.83 | 1:1.0000 |
| | | 10 | 20 | 1.17 | 1:2.0000 |
| | | 5 | 0.4 | 0.26 | 1:0.0800 |
| | | 5 | 4 | 0.38 | 1:0.8000 |
| | | 5 | 10 | 0.58 | 1:2.0000 |
| | | 5 | 20 | 0.92 | 1:4.0000 |
| | | 5 | 30 | 1.25 | 1:6.0000 |
| | | 2.5 | 20 | 0.79 | 1:8.0000 |
| | | 1.25 | 30 | 1.06 | 1:24.0000 |
| | | 0.65 | 30 | 1.03 | 1:46.1538 |
| | | 0.35 | 30 | 1.02 | 1:85.7143 |
| | | 0.17 | 30 | 1.01 | 1:176.4706 |

Ca: component in ppm AI of Silver-containing copolymer
Cb: component in ppm AI of DIMTS
Note:
MIC alone (CA and CB) is on the upper rows.

TABLE 3

| Test | Contact | | | | |
|---|---|---|---|---|---|
| Organisms | Time | Ca | Cb | S.I. | Ca:Cb |
| Ps. aeruginosa | 24 hrs | 10 | — | — | — |
| ATCC | | — | >1000 | — | — |
| #15442 | | | | | |
| | | 5 | 6 | 0.51 | 1:1.2000 |
| | | 5 | 60 | 0.56 | 1:12.0000 |
| | | 5 | 400 | 0.90 | 1:80.0000 |
| | | 5 | 500 | 1.00 | 1:100.0000 |
| | | 2.5 | 200 | 0.45 | 1:80.0000 |
| | | 2.5 | 300 | 0.55 | 1:120.0000 |
| | | 2.5 | 400 | 0.65 | 1:160.0000 |
| | | 2.5 | 500 | 0.75 | 1:200.0000 |
| | | 2.5 | 700 | 0.95 | 1:280.0000 |
| | | 2.5 | 800 | 1.05 | 1:320.0000 |
| | | 1.25 | 1000 | 1.13 | 1:800.0000 |

Ca: component in ppm AI of Silver-containing copolymer
Cb: component in ppm AI of DIMTS
Note:
MIC alone (CA and CB) is on the upper rows.

TABLE 4

| Test | Contact | | | | |
|---|---|---|---|---|---|
| Organisms | Time | Ca | Cb | S.I. | Ca:Cb |
| S. aureus | 24 hrs | 10 | — | — | — |
| ATCC #6538 | | — | 30 | — | — |
| | | 5 | 10 | 0.83 | 1:2.0000 |
| | | 5 | 20 | 1.17 | 1:4.0000 |
| | | 2.5 | 20 | 0.92 | 1:8.0000 |
| | | 2.5 | 30 | 1.25 | 1:12.0000 |
| | | 1.25 | 30 | 1.13 | 1:24.0000 |
| | 48 hrs | 40 | — | — | — |
| | | — | 400 | — | — |
| | | 30 | 4 | 0.76 | 1:0.1333 |
| | | 30 | 10 | 0.78 | 1:0.3333 |
| | | 30 | 40 | 0.85 | 1:1.3333 |
| | | 30 | 100 | 1.00 | 1:3.3333 |
| | | 30 | 200 | 1.25 | 1:6.6667 |
| | | 20 | 40 | 0.60 | 1:2.0000 |
| | | 20 | 60 | 0.65 | 1:3.0000 |
| | | 20 | 100 | 0.75 | 1:5.0000 |
| | | 20 | 200 | 1.00 | 1:10.0000 |
| | | 10 | 100 | 0.50 | 1:10.0000 |
| | | 10 | 300 | 1.00 | 1:30.0000 |
| | | 10 | 400 | 1.25 | 1:40.0000 |

Ca: component in ppm AI of Silver-containing copolymer
Cb: component in ppm AI of DIMTS
Note:
MIC alone (CA and CB) is on the upper rows.

The data demonstrate that there is an unexpected synergistic interaction between silver and DIMTS at ratios of 1/0.008 to 1/0.1 (C. albicans, 48 hr.), 1/0.13 to 1/8 (S. aureus, 48 hr., 1/0.13-1/5 & C. albicans, 72 hr., 1/1-1/8) and 1/120 to 1/280 (Ps. aeruginosa).

1. A synergistic microbicidal composition; said composition comprises: (a) silver ion; and (b) diiodomethyl-p-tolylsulfone; wherein a weight ratio of silver to diiodomethyl-p-tolylsulfone is from 1: 1/0.008 to 1/0.1, 1/0.13 to 1/8 or 1/120 to 1/280.

2. The composition of claim 1, wherein silver ion is present as a complex with a copolymer comprising polymerized units of a monomer X and a monomer Y; wherein monomer X is an ethylenically unsaturated compound having a substituent group selected from an unsaturated or aromatic heterocyclic group having at least one hetero atom selected from N, O and S; and wherein monomer Y is an ethylenically unsaturated compound selected from carboxylic acids, carboxylic acid salts, carboxylic acid esters, organosulfuric acids, organosulfuric acid salts, sulfonic acids, sulfonic acid salts, phosphonic acids, phosphonic acid salts, vinyl esters, (meth)acrylamides, C₈-C₂₀ aromatic monomers containing at least one exocyclic ethylenic unsaturation and combinations thereof.

3. The composition of claim 2, wherein the copolymer comprises 6.5 wt % to 8.5 wt % silver, based on total weight of copolymer and silver.

4. The composition of claim 3, wherein the copolymer comprises 35 to 55 wt % of units derived from monomer X and 45 to 65 wt % of units derived from monomer Y.

5. The composition of claim 4, wherein monomer X is N-vinylimidazole.

6. The composition of claim 5, wherein monomer Y comprises at least one alkyl (meth)acrylate.
